(19) United States
(12) Patent Application Publication
(10) Pub. No.: US 2008/0036581 A1
(43) Pub. Date: Feb. 14, 2008

(54) Seatbelt Adaptor

(76) Inventor: Jeffrey M. Bunims, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/463,071

(22) Filed: Aug. 8, 2006

(51) Int. Cl. B60Q 1/00; A44B 11/00; B60R 22/00

(52) U.S. Cl. 340/457.1; 280/801.1; 24/265 BC; 297/468

(57) ABSTRACT

An adaptor for modifying a seatbelt configuration includes a proxy seatbelt tongue. The proxy seatbelt tongue engages a sensor within a seatbelt buckle, thereby preventing the activation of a “fasten seat belt” warning or alarm. In various embodiments, the adaptor is coupled to an ignition key, contains a warning indication thereon, and is coupled to an alternative seatbelt or safety harness.

### BACKGROUND OF THE INVENTION

1. Field of the Invention

The invention relates to an adaptor and method for utilizing alternative seatbelt configurations.

2. Description of the Prior Art

An increased awareness of driver and passenger safety is being realized with the increased use of “street-legal automobiles” (i.e., automobiles licensed to be driven on public streets because they meet various regulations, including emission and safety standards) for off road and racing activities. While typical standard seatbelts having a waist/shoulder strap are suitable for most driving uses, more specialized belt or harness arrangements often are better suited for ensuring driver and passenger safety during racing or off-road applications.

Moreover, standard seatbelts are best suited for use by adults of average height and weight. Nonetheless, there are times when vehicle occupants fall outside of the “average” criteria, for example, adults of reduced height and children who are too big for a child safety seat but too small to be effectively secured by a seatbelt in the vehicle. For those occupants, alternative seatbelt arrangements are needed. Furthermore, restraining a pet in an automobile with the existing seatbelt holds the potential for serious injury because most belts obviously are not designed for safe operation with non-human anatomy in mind.

Many devices have been developed over the years to alter existing seatbelts in automobiles. In U.S. Pat. No. 4,799,737, an auxiliary adjusting device for the shoulder strap of a seat belt is described, with the device being mounted to a side wall of the vehicle at a given reduced height and having a yoke for guiding the shoulder strap through the device. Likewise, U.S. Pat. No. 4,796,919 discloses a clamp device for clamping the diagonal run of the shoulder belt to the vertical run of the shoulder belt to reduce the height of the diagonal run. In U.S. Pat. No. 4,946,198, an adaptor that includes a safety strap clipped between a shoulder belt fastener and a lap belt fastener is described.

While all of these modified belts may be suitable for their intended purpose, it would be desirable to facilitate the use of an “alternative” seatbelt or harness system (i.e., one that is distinct from the seatbelt that already is included in the vehicle). This is not accomplished by inventions that merely modify an existing belt.

Moreover, many specialized harnesses and safety belts are not designed to interface with an existing seatbelt buckle and instead attach to other structures within the vehicle. Thus, in some cases, a driver or passenger may desire to leave the exiting seatbelt “unbuckled.”

However, many (especially newer) vehicles have a feedback circuit that includes a contact or other sensor in the seatbelt buckle. The tongue of the seatbelt is designed to engage the contact sensor when placed within the receiving slot of the buckle. Hence, if a seatbelt is left unbuckled while the vehicle is running, the sensor informs a microprocessor of the “unbuckled status” that then leads to a warning indicator (e.g., a dashboard message and/or audible warning or alarm).

In order to stop or silence the warning indicator, an automobile occupant could fasten the existing seatbelt tongue into the buckle. However, the occupant then has to either put the existing seatbelt over the alternative seatbelt or sit on the fastened existing belt. Placing the existing seatbelt over the top of a different belt or harness may not be ideal because the properties (e.g., tension) of the existing belt may be affected and lead to performance issues during a crash. Moreover, wearing several different seatbelts at the same time may lead to an undesirable or awkward restriction of the occupant's range of movement.

Similarly, sitting on the fastened existing seatbelt can be uncomfortable and could be awkward depending on the seatbelt design. For example, if the buckle extends outwardly from the seat, an occupant's elbow or arm might hit the buckle or “catch” in the space between the existing belt and the seat.

### SUMMARY OF THE INVENTION

The invention relates in general to an adaptor for modifying a seatbelt configuration that includes a proxy seatbelt tongue. The proxy seatbelt tongue engages a buckle, and, preferably, a sensor within a seatbelt buckle, which prevents the activation of a “fasten seat belt” warning or alarm.

In one embodiment of the invention, an adaptor including a proxy seatbelt tongue is adapted to reversibly engage a seatbelt buckle attached to an automobile's seating and includes a surface displaying a warning indication. Preferably, the warning indication reminds a user to remove the proxy seatbelt tongue upon leaving a vehicle so that the next user is reminded to fasten the existing seatbelt (in automobiles equipped with a seatbelt warning feature).

In another embodiment of the invention, the adaptor is beltless. Thus, the proxy seatbelt tongue is unencumbered by a seatbelt structure so that a user is not confused as to whether a particular belt is part of the adaptor or part of the existing seatbelt.

In yet another embodiment of the invention, the proxy seatbelt tongue further includes a tether. The tether may be coupled to another object, such as an ignition key for the automobile, as a reminder to remove the proxy seatbelt tongue before or while a user exits the vehicle. The tether may also couple the proxy seatbelt tongue to an alternative seatbelt or harness.

In a method embodiment of the invention, a process for facilitating the use of alternative seatbelt configurations includes providing a proxy seatbelt tongue adapted to engage a seatbelt buckle, engaging the seatbelt buckle in the automobile with the proxy seatbelt tongue, and providing an alternative seatbelt or harness within the automobile. Preferably, a proxy seatbelt tongue adapted to be detected by a sensor harbored within the seatbelt buckle is provided such that an automobile microprocessor “detects” a fastened seatbelt, thereby preventing a seatbelt warning indicator from activating.

Also preferably, the method of the invention further includes the step of removing the proxy seatbelt tongue from the seatbelt buckle before exiting the automobile.

In another method embodiment, a proxy seatbelt tongue adapted to engage a seatbelt buckle is provided for engaging the seatbelt buckle in the automobile, with the proxy seatbelt tongue also being adapted to be detected by a sensor harbored within the seatbelt buckle, thereby preventing a seatbelt warning indicator from activating.

Additional features and advantages of the invention will be forthcoming from the following detailed description of certain specific embodiments when read in conjunction with the accompanying drawings.

### BRIEF DESCRIPTION OF THE DRAWINGS

FIG. 1 is simplified schematic diagram showing an automobile seat, partial seatbelt arrangement, and a seatbelt status (buckled or not buckled) system.

FIG. 2 is a plan view of a first embodiment of the invention.

FIG. 3 is a plan view of a second embodiment of the invention.

FIG. 4 is a flow chart depicting steps in a method embodiment of the invention.

FIG. 5 is a fragmentary plan view illustrating a third embodiment of the invention as used inside an automobile.

### DESCRIPTION OF THE PREFERRED EMBODIMENTS

As used herein, a “proxy seatbelt tongue” means a tongue that is provided after the vehicle is manufactured, i.e., a tongue other than the one that originally is installed inside the automobile for a particular seatbelt buckle.

The terms “alternative seatbelt or harness” mean a seatbelt or safety harness that is provided after the vehicle is manufactured, i.e., a seatbelt or harness other than those originally installed inside the automobile.

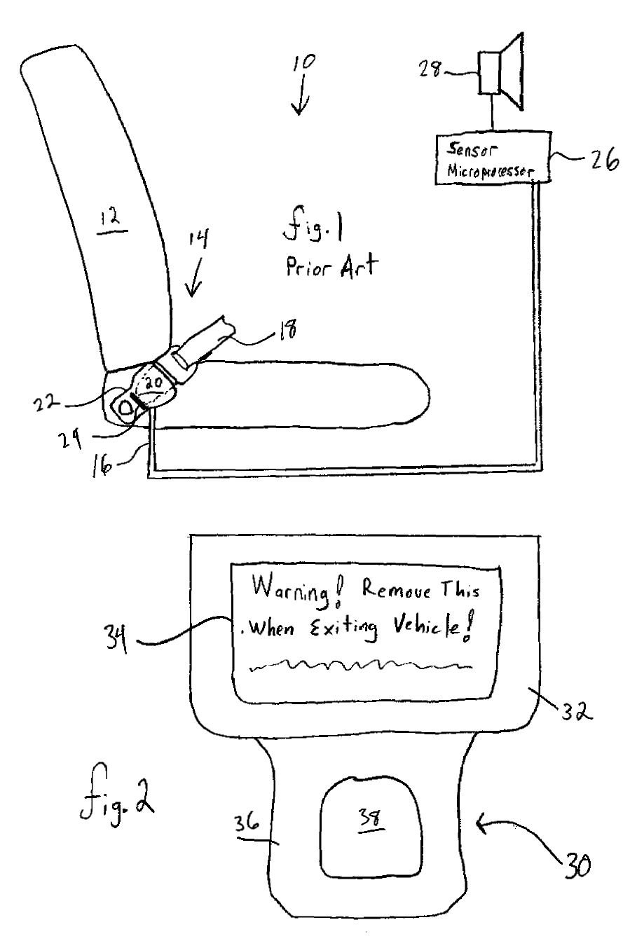

Referring to FIG. 1, the numeral 10 identifies a simplified representation of a prior art “seat belt warning” system common in many automobiles. The system 10 includes an automobile seat 12, seatbelt arrangement 14, and a seatbelt status circuit 16. The seatbelt arrangement 12 typically includes a seatbelt 18 attached to a tongue 20, with the tongue being shown in the engaged position inside a buckle 22 that has a contact sensor 24 is located inside.

When the tongue 20 is engaged within buckle 22, sensor 24 informs a microprocessor 26 via circuit 16 that the seatbelt 18 is fastened during the appropriate decision time (e.g., when ignition of the automobile is commenced). Conversely, if the sensor 24 does not detect the tongue 20 at the appropriate decision time, the microprocessor 26 actuates audible alarm 28. Depending on the automobile, a different seatbelt warning indicator (e.g., a voice or dashboard warning) or a combination of indicators may be actuated.

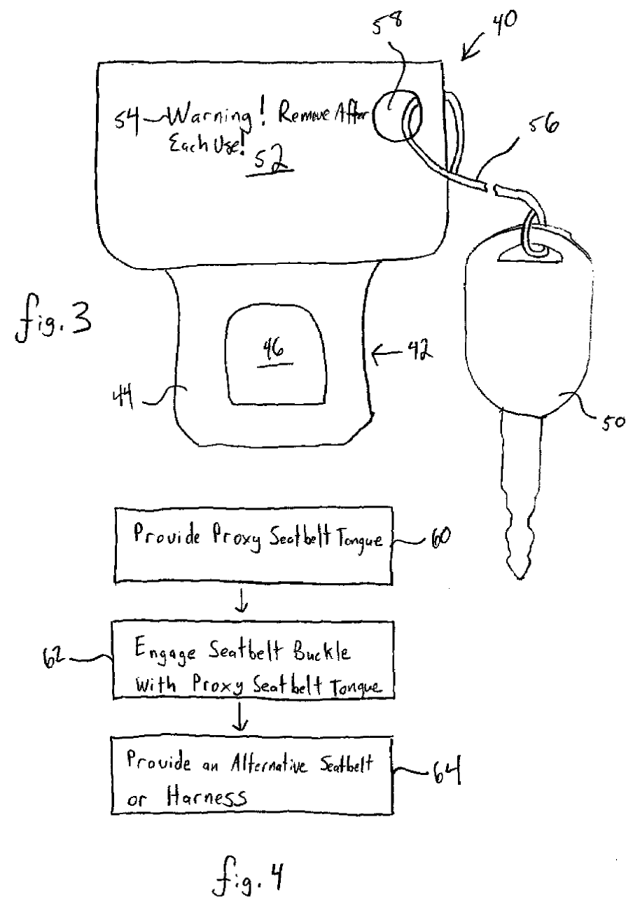

Turning to FIG. 2, a first embodiment of the invention is illustrated. This embodiment includes a proxy seatbelt tongue 30 that includes a surface 32 for displaying a warning indication 34. Preferably, the warning indication includes a message to the user to remove the adaptor when exiting the automobile as a safety precaution for the next vehicle user.

The tongue 30 may be beltless so that no seatbelt strap structure is attached to the tongue, thereby eliminating additional bulk and weight. Moreover, the tongue 30 is adapted to reversibly engage a seatbelt buckle for a given automobile. Typically, this adaptation is in the form of the tongue 30 having a tab member 36 and an opening 38 of the appropriate dimensions to fit inside a particular automobile's seatbelt buckles and to engage a latch mechanism located within the buckle or otherwise engage the buckle (depending on the particular seatbelt).

Preferably, the tongue 30 also is adapted to be detected by a sensor that detects a fastened seatbelt and is harbored within a seatbelt buckle, thereby preventing a seatbelt warning indicator from activating. This adaptation typically takes the form of a tongue 30 that is sized and dimensioned to engage a contact sensor. However, the tongue also may be adapted to engage other types of sensors (e.g., electro-magnetic or optical sensors) that may be disposed inside a buckle.

In FIG. 3, a third embodiment of the invention, adaptor 40, is illustrated. The adaptor 40 includes a proxy seatbelt tongue 42 having a tab 44 and an opening 46 coupled to an automobile ignition key 50. The adaptor 40 further includes a surface 52 upon which a warning indicator 54 is displayed. In this case, the key 50 is coupled to the adaptor 40 through a tether 56 disposed through aperture 58 in surface 52. Of course, the tether 56 may assume a variety of configurations and be constructed from a variety of materials.

As in previous embodiments, the proxy seatbelt tongue 42 preferably is adapted to be detected by a sensor that detects a fastened seatbelt.

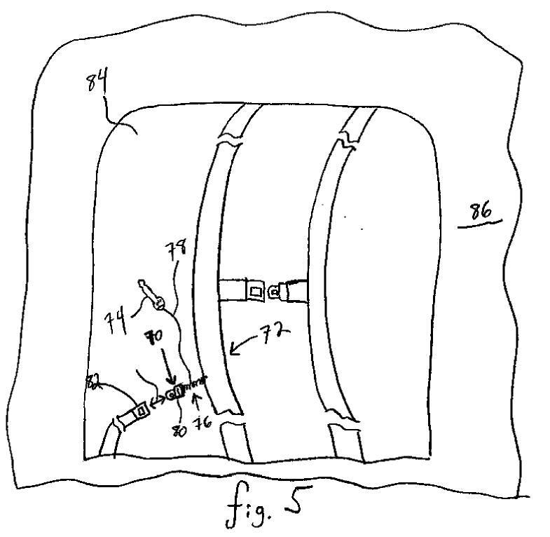

Turning to FIG. 4, a method according to the invention for facilitating alternative seatbelt use in an automobile is depicted. The method includes the steps of providing a proxy seatbelt tongue (62), engaging a seatbelt buckle with the proxy seatbelt tongue (64), and providing an alternative seatbelt or harness within the automobile (66). In vehicles so equipped, the first step of this embodiment preferably includes providing a proxy seatbelt tongue adapted to be detected by a sensor such that the automobile detects a fastened seatbelt, thereby preventing a seatbelt warning indicator from activating. Hence, for example, an off-road enthusiast may use a three-point harness in her truck instead of the existing seatbelt without having to disable the seatbelt warning system.

In other embodiments, the method depicted in FIG. 4 also may include providing a proxy seatbelt tongue coupled to an ignition key and/or providing a proxy seatbelt tongue that includes a surface displaying a warning indication thereon.

The invention further includes a method for facilitating alternative seatbelt use in an automobile that includes the steps of providing a proxy seatbelt tongue adapted to engage a seatbelt buckle and engaging the seatbelt buckle in the automobile with the proxy seatbelt tongue, wherein the proxy seatbelt tongue is adapted to be detected by a sensor harbored in the buckle such that a seatbelt warning indicator is prevented from activating. In this manner, the noise and/or distraction of the warning indicator is obviated.

As illustrated in FIG. 5, another embodiment of the invention includes a proxy seatbelt tongue 70 that is coupled to an alternative seatbelt or harness 72 and an ignition key 74 via an elastic tether 76 and a cord 78. Thus, the tongue 70 is stretched to engage buckle 82, which is attached to seat 84 within the interior 86 of an automobile. At the same time, the user of the alternative seatbelt or harness 72 is reminded to remove the tongue 70 through a warning indication 80 disposed on tongue 70 and through the coupling of the tongue 70 to the ignition key 74.

Various modifications are possible within the meaning and range of equivalence of the appended claims.

We claim:

1. An adaptor for modifying a seatbelt configuration within an automobile, comprising a proxy seatbelt tongue, said tongue being adapted to reversibly engage a seatbelt buckle attached to said automobile's seating, that includes a surface displaying a warning indication thereon.

2. The adaptor of claim 1, wherein said warning indication comprises to remove the adaptor when exiting said automobile.

3. The adaptor of claim 1, wherein said proxy seatbelt tongue further is adapted to be detected by a sensor that detects a fastened seatbelt and is harbored within said seatbelt buckle, thereby preventing a seatbelt warning indicator from activating.

4. The adaptor of claim 1, wherein said proxy seatbelt tongue is beltless.

5. The adaptor of claim 1, wherein said proxy seatbelt tongue further includes a tether coupled thereto.

6. The adaptor of claim 1, wherein said proxy seatbelt tongue is coupled to an alternative seatbelt or harness.

7. An apparatus, comprising a proxy seatbelt tongue coupled to an automobile ignition key.

8. The apparatus of claim 7, wherein said proxy seatbelt tongue is coupled to said key with a tether.

9. The apparatus of claim 8, wherein said tether is elastic.

10. The apparatus of claim 7, wherein said proxy seatbelt tongue further includes a surface displaying a warning indication thereon.

11. The apparatus of claim 10, wherein said warning indication comprises to remove the adaptor when exiting said automobile.

12. The apparatus of claim 7, wherein said proxy seatbelt tongue further is adapted to be detected by a sensor that detects a fastened seatbelt and is harbored within said seatbelt buckle, thereby preventing a seatbelt warning indicator from activating.

13. The apparatus of claim 7, wherein said proxy seatbelt tongue is beltless.

14. The apparatus of claim 7, wherein said proxy seatbelt tongue further is coupled to an alternative seatbelt or harness.

15. A method for facilitating alternative seatbelt use in an automobile, comprising the steps of:
providing a proxy seatbelt tongue adapted to engage a seatbelt buckle,
engaging said seatbelt buckle in said automobile with said proxy seatbelt tongue; and
providing an alternative seatbelt or harness within said automobile.

16. The method of claim 15, wherein step (a) comprises providing a proxy seatbelt tongue adapted to be detected by a sensor harbored within said seatbelt buckle such that the automobile detects a fastened seatbelt, thereby preventing a seatbelt warning indicator from activating.

17. The method of claim 15, wherein step (a) includes providing a proxy seatbelt tongue coupled to an ignition key.

18. The method of claim 15, wherein step (a) includes providing a proxy seatbelt tongue that includes a surface displaying a warning indication thereon

19. The method of claim 15, further including the step of removing the proxy seatbelt tongue from the seatbelt buckle before exiting said automobile.

20. A method for facilitating alternative seatbelt use in an automobile, comprising the steps of:
providing a proxy seatbelt tongue adapted to engage a seatbelt buckle; and
engaging said seatbelt buckle in said automobile with said proxy seatbelt tongue, wherein the proxy seatbelt tongue is adapted to be detected by a sensor harbored within said seatbelt buckle such that the automobile detects a fastened seatbelt, thereby preventing a seatbelt warning indicator from activating.
